(19) United States
(12) Patent Application Publication
(10) Pub. No.: US 2009/0129290 A1
(43) Pub. Date: May 21, 2009

(54) Method for acquiring information of network resources connected to ports of network switches

(75) Inventors: Seung-ho Seo, Daegu (KR); Youn-kyoung Na, Gyeongsangbuk-do (KR)

Correspondence Address: RABIN & Berdo, PC, 1101 14TH STREET, NW, SUITE 500, WASHINGTON, DC, 20005, US

(73) Assignee: NetMan Co., Ltd., Daegu (KR)

(21) Appl. No.: 11/984,476

(22) Filed: Nov. 19, 2007

(51) Int. Cl. H04L 12/28

(52) U.S. Cl. 370/254

(57) ABSTRACT

Provided is a method for acquiring information of network resources connected to ports of network switches. The method includes the steps of: acquiring network resource information including IP address, MAC address, computer name, and workgroup name of the network resources in a network including one or more network switches and a plurality of network resources connected to the switches; acquiring information of the ports of the switches and MAC address information of the network resources connected to ports of the switches; and matching the port-based resource information on the basis of the acquired network resource information and the acquired MAC address information of the network resource information based on the ports of the switches.

### BACKGROUND OF THE INVENTION

1. Field of the Invention

The present invention relates to a method for acquiring network configuration information, and more particularly, to a method for acquiring information of network resources connected to ports of network switches (e.g., L2/L3 switches) for confirming network load locations or network topology.

2. Description of the Related Art

Generally, a network management system (NMS) provides a network topology management function which is fundamental in a configuration management so as to provide a function of confirming information of physical/logical network configurations, investigating a network failure, and managing an isolation.

To provide the configuration information of the network topology, a conventional NMS acquires configuration information of network resources, e.g., MAC address, IP address, and computer name by using protocols such as ARP, NetBIOS, SNMP, ICMP, and Traceroute. Typically, the function of the conventional NMS is executed by a network management tool such as HP's Network Node Manager (NNM).

The NNM acquires the resources connected to the network by using a variety of protocols and displays or outputs the acquired resources in a hierarchical map structure: Internet sub-map representing uppermost layer, network sub-map based on a gateway and a sub-network under the Internet sub-map, segment sub-map displaying segment unit of the sub-network, and node sub-map displaying nodes of the segment.

When the network connection resources are displayed or outputted in the hierarchical map structure, a visual view for an overall network configuration can be provided to users. Further, the users can easily check logical connection states of the network connection resources.

By acquiring the network resource information and checking its configuration information using the network node manager, it is possible to check general characteristics and states of the network configuration by expressing the physical location and connection information of the network in a sub-net of gateway and logical unit, and segment and node unit, but it is impossible to quickly check a physical location of a system causing a network failure.

That is, the conventional network management tool displays information on network resources and connection states of the network resources, but cannot check information on which switch (e.g., an L2 switch) the corresponding resource is connected to and which port of the switch the corresponding resource is connected to, or information on which resource is connected to a specific port of the switch. Therefore, when finding the source of abnormal phenomenon such as overload or a location where destination equipment is placed in Internet, intranet or sub-net, the manager cannot use the existing network management tool but must again find the resources manually.

In practice, the management of the overload network resources is performed by blocking a traffic through a separate security system such as Intrusion Prevention System (IPS)/Intrusion Detection System (IDS) rather than finding the resources causing the overload. However, even the use of the IPS/IDS cannot check information on which location the equipment causing the problem is placed, or information on which system the equipment causing the problem is connected to. Also, the manager must depend on the manual management.

Further, when performing the management of physical links of the resources connected to the switches in the actual network configuration, that is, the connection resource check and rearrangement, and the configuration modification, the manager must separately check the switches and the connection cables of the resources connected to the switches, or must index the cables manually.

### SUMMARY OF THE INVENTION

An object of the present invention is to provide a method for acquiring information of network resources connected to ports of network switches, in which port configuration information of network switches and identification information of the network resources connected to the ports are acquired, thereby making it possible to check which switch the corresponding network resource is connected to, which port of the switch the corresponding network resource is connected to, or which resource is connected to the specific port of the switch.

According to aspect of the present invention, a method for acquiring information of network resources connected to ports of network switches includes the steps of: acquiring network resource information including IP address, MAC address, computer name, and workgroup name of the network resources in a network including one or more network switches and a plurality of network resources connected to the switches; acquiring information of the ports of the switches and MAC address information of the network resources connected to ports of the switches; and merging IP address, computer name, and workgroup name of the network resource information, based on the MAC address information, thereby making it possible to check which switch the corresponding network resource is connected to, which port of the switch the corresponding network resource is connected to, or which resource is connected to the specific port of the switch.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an overall system to which a method for acquiring information of network resources connected to ports of network switches according to an embodiment of the present invention is applied;

FIG. 2 illustrates a specific embodiment of the overall system of FIG. 1;

FIG. 3 is a block diagram of a manager system according to an embodiment of the present invention;

FIG. 4 is a flowchart illustrating the operation of acquiring the network resource information according to an embodiment of the present invention;

FIG. 5 is a flowchart illustrating the operation of acquiring the network resource information, based on the ports of the network switches according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

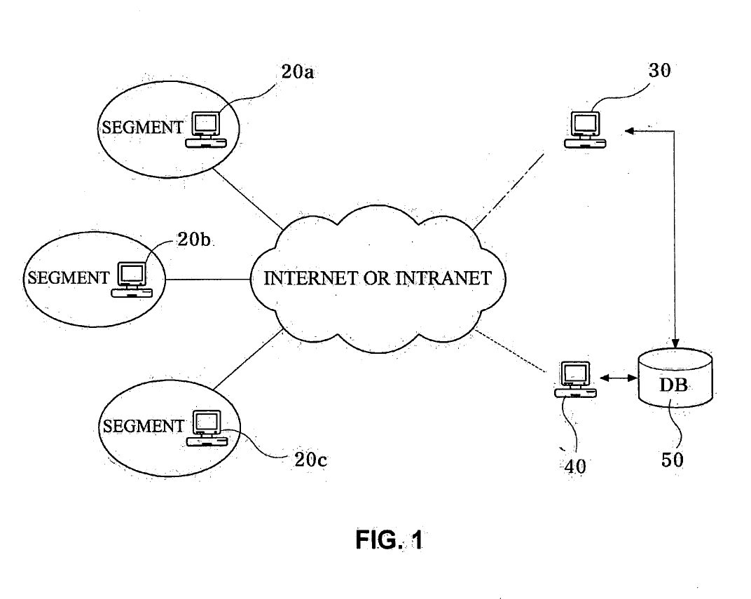

Referring to FIG. 1, a method for acquiring network resource information in each port of a network switch according to an embodiment of the present invention is applied to a network including one or more network switches and a plurality of network resources connected to each switch. More specifically, the method is carried out by a system that includes a plurality of agents 20a, 20b and 20c, a console 300, a manager system 40, and a database 50. The agents 20a, 20b and 20c are installed in segments of the network and are allocated IP addresses. The console 300 and the manager system are accessible to the agents 20a, 20b and 20c via Internet or intranet. The database 50 stores a variety of information.

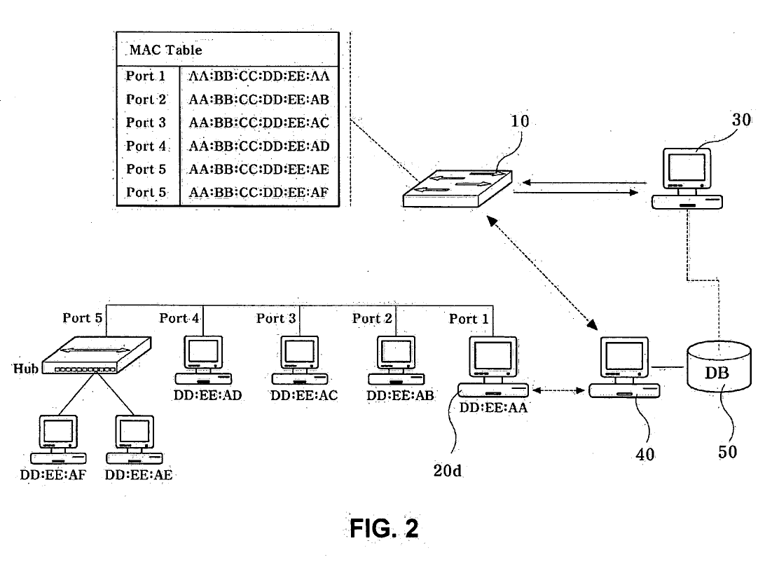

FIG. 2 illustrates an overall system to which the method of the present invention is applied. The system includes a MAC address table of network resources connected to the ports of the switches. An L2 switch having a specific port Port1 connected to an agent 20d is used as a network switch 10. A console 30 and a manager system 40 are accessible to the agent 20d. A database 50 stores a variety of information.

The network switch 10 basically uses a transparent technology that executes a function of transmitting an inputted packet to a destination without other manipulation. The network switch 10 includes the MAC address table containing information on specific ports and MAC address information of network sources connected to the specific ports. The MAC address table is a table for determining whether to transmit packets received through the network switch. The MAC address table contains information on destination MAC address and port to transmit the packets.

The agent 20d is installed in each segment of the network. The agent 20d acquires network resource information including IP address, MAC address, computer name, and workgroup name and communicates with the manager system 40.

The console 30 receives configuration information of the agent installed in each segment, IP address information of the network switch 10 such as the L2 switch, and community (or password) information, and stores the received information in the database 50. The console 30 provides basic information necessary for the manager system 40 to acquire resource information.

The console 30 acquires the MAC address information in each port of the specific network switch 10 in real time. Based on the acquired MAC address information, the console 30 searches IP address information of the network resources allocated to the MAC address, the computer name, and the workgroup name from the database 50 and merges the searched information. Thus, the console 30 can check which switch of the network the specific network resource is connected to, or which port of the switch the specific network resource is connected to. Further, the console 30 can easily check the network configuration, reconfigure the network, or check system failure in the ports of the switches.

By requesting to the agent 20d, the manager system 40 acquires network resource information including IP address, MAC address, computer name, and workgroup name of the network resources existing in each segment of the network and establishes the database of the acquired information. If the manager system 40 does not acquire the network resource information from the agent, the manager system 40 accesses the layer3 (L3) or higher switch in the console 50 or the gateway of the corresponding network, acquires ARP table information, that is, the IP address information and MAC address information of the network resources, and establishes the database of the acquired information. The gateway or the L3 or higher switch holds the IP address information and the MAC address information of the resources connected to the network in the ARP table.

The manager system 40 acquires the MAC address information of the network resources connected to the ports of the switches 10, based on the IP addresses and community (or password) information of the network switches 10 registered through the control 50. Then, the manager system 40 searches the IP address information, the computer name, and the workgroup name of the network resources allocated to the MAC addresses from the database 50, based on the acquired MAC address information, and merges the searched information. Thus, the manager system 40 establishes the database of the network resources based on the ports of the switch, including the specific ports, the MAC address, the IP address, the computer name, and the workgroup name of the network resources, so as to check which switch of the network the specific network resource is connected to, or which port of the switch the specific network resource is connected to.

The manager system 40 quickly applies the changed network resources by periodically acquiring the network resource information (IP address, MAC address, computer name, workgroup name) and the MAC address information based on the ports of the network switch from the agent 20d or the switch/gateway.

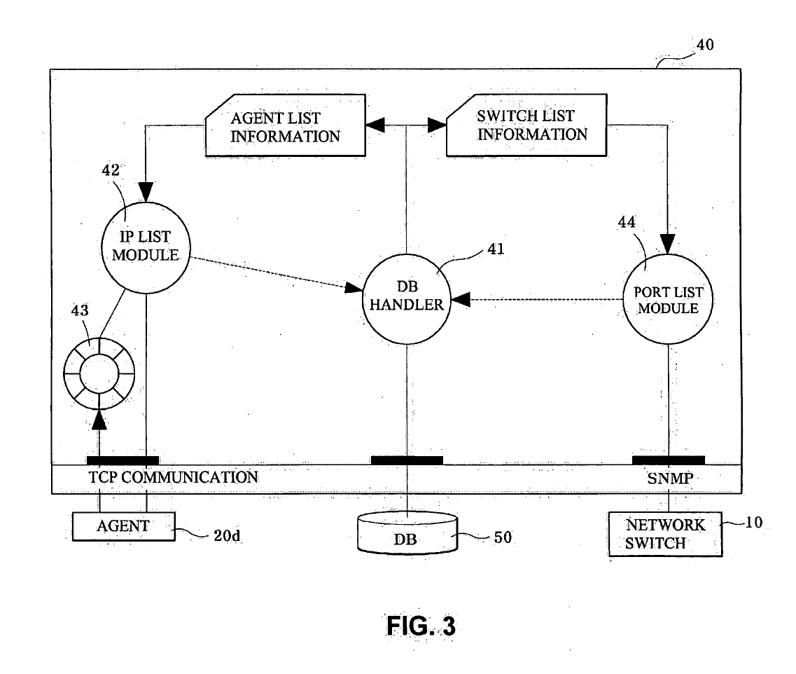

FIG. 3 is a block diagram of the manager system according to an embodiment of the present invention.

Referring to FIG. 3, the manager system 40 includes a database handler 41, an IP list module 42, a queue 43, and a port list module 44.

The database handler 41 handles the operation of read/writing data to/from the database 50.

The IP list module 42 requests and receives the network resource information while communicating with the agents 20d installed in each segment of the network or the L3 or higher switch or the gateway, and stores the network resource information in the database 50.

The queue 43 sequentially stores the collected network resource information and transmits it to the IP list module 42.

The port list module 44 requests the switch list information stored in the database 50 and acquires the MAC address information while communicating with one or more network switches 10 of the network. Further, the port list module 44 acquires the MAC address information of the network resources connected to the ports of the switches 10, searches the IP address information, the computer name, and the workgroup name of the network resources allocated to the MAC addresses from the database 50, based on the MAC address information, and merges the searched information. Thus, the port list module 44 establishes the database of the network resources based on the ports of the switch, including the specific ports, the MAC address, the IP address, the computer name, and the workgroup name of the network resources, so as to check which switch of the network the specific network resource is connected to, or which port of the switch the specific network resource is connected to.

A method for acquiring network resource information based on the ports of the network switches in accordance with an embodiment of the present invention will be described below.

The method includes the steps of: acquiring network resource information, such as IP address, MAC address, computer name, and workgroup name of the network resources, in a network including one or more network switches and a plurality of network resources connected to the switches; acquiring MAC address information of the network resources connected to ports of the switches; and checking which switch a specific network resource is connected to and which port of the switch the specific network source is connected to by merging the IP address, the computer name, and the workgroup name of the network resource information, based on the MAC address.

1. Operation of Acquiring the Network Resource Information

This step is carried out by communication between the manager system 40 and the agent 20d. The IP list module 42 of the manager system 40 requests the agent list information stored in the database 50 and requests and receives the network resource information while communicating with the agents 20d installed in each segment of the network.

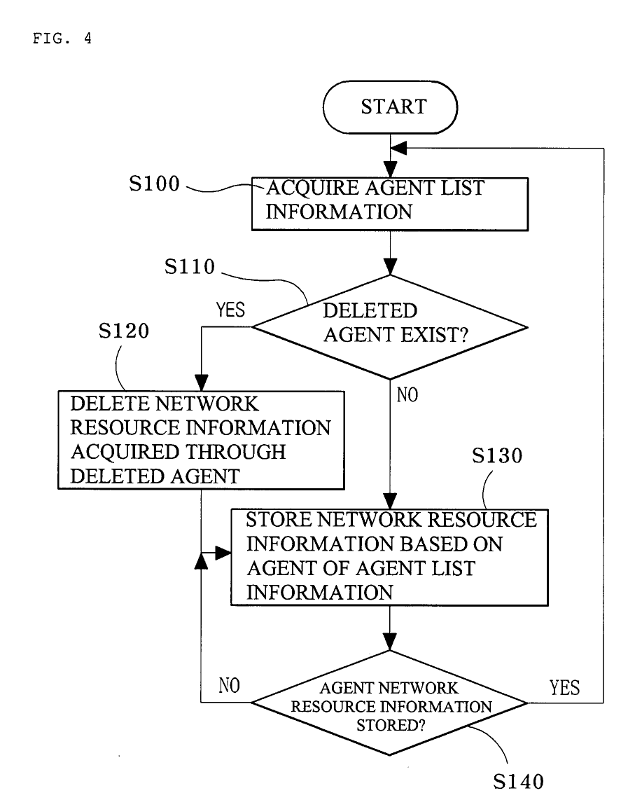

FIG. 4 is a flowchart illustrating the operation of acquiring the network resource information according to an embodiment of the present invention.

Referring to FIG. 4, the IP list module 42 acquires the agent list information on the agents, which are installed in each segment of the network and allocated IP addresses, from the database 50 through the database handler 41 in step S100.

In step S110, whether a deleted agent exists is determined by comparing the acquired agent list information with a previously acquired agent list information.

In step S120, if there is a deleted agent, the IP list module 42 updates the network resource information of the database 50 by deleting all network resource information previously acquired from the deleted agent.

In steps S130 and S140, if there is no deleted agent or the network resource information acquired from the deleted agent is deleted, the IP list module 42 requests the network resource information, which is collected by the agents 20d, to the agents 20d installed in each segment of the network in sequence, based on the IP addresses of the agents of the agent list information. When the agents 20d transmit their collected network resource information, the network resource information is sequentially stored in the queue 43 and stored in the database 50 through the IP list module 42 and the database handler 41.

When the network resource information of the agents is completely stored in the database 50, the IP list module 42 returns to step S100 after a preset waiting time and periodically updates the network resource information.

According to another embodiment of the present invention, information on the MAC address information and information on the IP address allocated to the MAC address can be acquired through the ARP table information. The ARP is a protocol to match the MAC address with IP address or matching IP address with MAC address. The switch supporting L3 or higher function or the gateway of the corresponding network maintains the MAC address of the network resources, which passed through the switch or the gateway, and the IP address, which is matched with the MAC address, in a table. This is called an ARP table. Therefore, the information on the MAC address of the network resources and the information on the IP address matched with the MAC address are obtained by acquiring the ARP table information of the L3 or higher switch or gateway equipment. Thus, the network resource information is maintained.

2. Operation of Acquiring MAC Address Information of Network Resources Connected to Ports of Switches

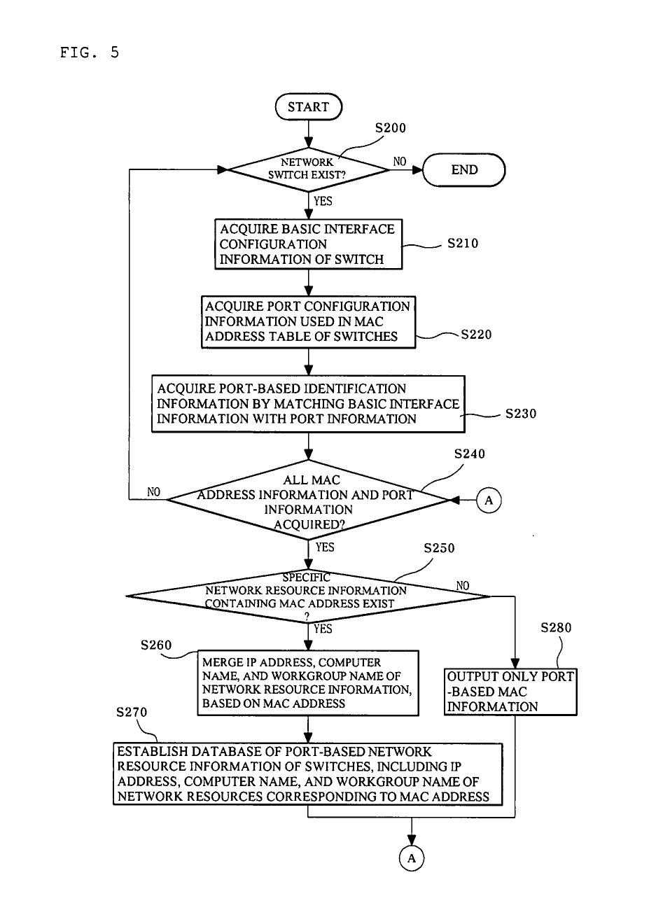

FIG. 5 is a flowchart illustrating the operation of acquiring the network resource information based on the ports of the network switches according to an embodiment of the present invention. This operation is carried out in the manager system 40.

Referring to FIG. 5, in step S200, the port list module 44 acquires the switch information list, including IP address information and the community (or password) information, from the database 50 through the database handler 41 in such a state that the network resource information collected by the agents 20d installed in each segment of the network is stored in the database 50, and then determines whether the switch information list exists in the database.

In steps S210 and S220, if the switch information list exists in the database 50, the port list module 44 accesses the respective switches and continuously acquires basic interface configuration information and port configuration information. The basic interface configuration information includes information on number of interface of the switches 10, interface index information, interface description information, interface name information, and interface alias information. The port configuration information includes information on port number used in the MAC address table of the switches 10, and information on interface index number connected to the corresponding port.

In step S230, when the basic interface information and the port configuration information are all acquired, the port list module 44 acquires the port-based identification information of the switches by matching the basic interface information and the port configuration information. At this point, when the interface index number of the basic interface information is matched with the interface index number of the port configuration information, the port identification information including specific interface description, name and alias information corresponding to the interface index information is acquired.

In step S240, after the port-based identification information of the switches is acquired, the port list module 44 acquires the port number, which is the MAC address table information of the switches 10, and the MAC address information of the network resources connected to each port number.

Through these procedures, the port information of the network switch and the MAC address information of the network resources connected to each port are acquired.

3. Operation of Checking Which Switch the Specific Network Resource is Connected to, and Which Port of the Switch the Specific Network Resource is Connected to by Merging IP Address, Computer Name, and Workgroup Name, Based on the MAC Address Information Acquired in Each Port

This operation is carried out by the manager system 40 and the console 30.

When the present invention is performed between the manager system 40 and the console 30, the manager can directly check which switch the corresponding network resource is connected to, which port of the switch the corresponding network resource is connected to, or which resource is connected to the specific port of the switch because the console 30 outputs the port-based network resource information of the switches, including IP address, computer name, and workgroup name of the network resources corresponding to the specific MAC address.

In step S250, after the MAC address information and the port-based identification information of the switches are acquired, the port list module 44 determines whether the specific network resource information containing the MAC information exists in the database 50. In this step, the port list module 44 determines whether the specific network resource information containing the MAC information exists in the database 50 through the database handler 41.

In step S260, when the specific network resource information containing the MAC information exists in the database 50, the port list module 44 merges the IP address information, the computer name, and the workgroup name of the network resource information, based on the MAC address information. In step S270, the port list module 44 establishes the database of the network resources based on the ports of the switch, including the specific ports, the MAC address, the IP address, the computer name, and the workgroup name of the network resources, so as to check which switch of the network the specific network resource is connected to, or which port of the switch the specific network resource is connected to.

In step S280, when the specific network resource information containing the MAC information does not exist in the database 50, the port list module 44 establishes only the MAC address based on the ports.

As described above, the port list module 44 of the manager system 40 requests the switch list information stored in the database 50, acquires the MAC address information while communicating with one or more network switches 10 of the network, and establishes the database of the port-based network resource information of the switches, including IP address, computer name, and workgroup name of the network resources corresponding to the specific MAC address. Thus, when the manager manages physical links of the resources connected to the switches 10, for example, connection resource checking, rearrangement, and configuration modification, or when the manager operates the separate security equipments, such as IPS/IDS, the manager can check which switch the specific network resource is connected to, which port of the switch the specific network resource is connected to, or which resource is connected to the specific port of the switch 10.

As described above, the limitation of the conventional manual checking can be solved in checking the network resource connected to the switch. Also, the network resource information based on the ports of the switches or the information on the switches and ports connected to the network resources can be automatically checked. In this way, the physical position of the specific network resource can be easily checked and the reconfiguration can be easily achieved. Further, by checking the position of the overloaded resource or the information on the port connected to the overloaded resource, network failure or overload can be quickly managed based on the ports of the switches, for example by cutting off the overload or failure position.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for acquiring information of network resources connected to ports of network switches in a network including one or more network switches and a plurality of network resources connected to the respective switches, the method comprising the steps of:
acquiring port configuration information of the switches and information of network resources connected to the ports; and
checking which switch a specific network resource is connected to and which port of the switch the specific network source is connected to.

2. The method of claim 1, wherein the step of acquiring the port configuration information of the switches comprises the steps of:
accessing the network switches to acquire MAC address table information; and
checking information on a specific port of the network switch and information on MAC address connected to the specific port.

3. The method of claim 1, wherein the port configuration information comprises inherent port information that identifies port identification index, network interface index allocated to port, network interface name, description, and alias of switch port.

4. The method of claim 1, wherein the network resource information connected to the ports comprises inherent network identification information of the network resources, including inherent MAC address information, IP address information, and computer name information of the network resources connected to the ports.

5. A method for acquiring information of network resources connected to ports of network switches, the method comprising the steps of:
acquiring network resource information including IP address, MAC address, computer name, and workgroup name of the network resources in a network including one or more network switches and a plurality of network resources connected to the switches;
acquiring information of the ports of the switches and MAC address information of the network resources connected to ports of the switches; and
matching the port-based resource information on the basis of the acquired network resource information and the acquired MAC address information of the network resource information based on the ports of the switches.

6. The method of claim 5, wherein in the step of acquiring the network resource information, when one or more agents for collecting network resource information are installed in each segment of the network, an IP list module acquires network resource information collected by the agents through communication with the agents, and outputs or stores the acquired network resource information.

7. The method of claim 5, wherein in the step of acquiring the network resource information, when the network resource information is not acquired from the agents, or when the agents are not installed, an IP list module accesses a switch supporting layer3 (L3) or higher service or a gateway equipment of the network and obtains the network resource information by acquiring ARP table information, which is IP address of ARP table MAC address information matched with the corresponding IP address.

8. The method of claim 5, wherein the step of acquiring the information of the ports of the switches and the MAC address information of the network resources comprises the steps of:
acquiring the network interface information by accessing a switch based on the IP address and community (or password) information of the network switches;
acquiring the port configuration information in the MAC address tables of the respective switches; and
acquiring the port-based identification information of the switches by matching the port configuration information with the basic interface configuration information.

9. The method of claim 8, wherein the step of acquiring the network interface information comprises the step of acquiring separate or integrated interface configuration information, including information on number of interface of the switches, interface index information, interface description information, interface name information, and interface alias information.

10. The method of claim 8, wherein the step of acquiring the port configuration information comprises the step of acquiring information on port number used in the MAC address table of the switches, and information on interface index number connected to the corresponding port, after acquiring the basic interface configuration information.

11. The method of claim 5, wherein in the step of acquiring the information of the ports of the switches and the MAC address information of the network resources, the port information and the port-based MAC address information are acquired from the switches by acquiring destination MAC address information for transmitting or filtering packets inputted to the switches, and port information of the switches for reaching the acquired MAC address, based on IP address information and community or password information of the switches.

12. The method of claim 5, wherein in the step of matching the port-based resource information, when specific network resource information containing MAC address is acquired from IP list module at agents installed in each segment, or when the network resource information is acquired from L3 or higher switch or ARP table of a gateway, IP address of the network resource, computer name and workgroup name are searched and merged based on MAC address information acquired based on the switch ports and MAC address acquired from the IP list module, and the port-based network resource information of the switches is outputted or stored, the port-based network resource information including specific port, MAC address of the corresponding network resource, IP address, computer name, and workgroup name.
